(19) United States
(12) Patent Application Publication
(10) Pub. No.: US 2014/0257880 A1
(43) Pub. Date: Sep. 11, 2014

(54) METHOD AND SYSTEM FOR LOYALTY REWARD REDEMPTION FOR EVENT TICKETS

(71) Applicant: Fanxchange, (US)

(72) Inventor: Brandon Koffler, Toronto (CA)

(73) Assignee: FANXCHANGE, Toronto (CA)

(21) Appl. No.: 13/790,546

(22) Filed: Mar. 8, 2013

(51) Int. Cl. G06Q 10/02; G06Q 30/02

(52) U.S. Cl. CPC G06Q 10/02; G06Q 30/0233
USPC 705/5

(57) ABSTRACT

A system and method are provided for loyalty reward redemption for event tickets. The computer implemented method includes displaying on a website accessible via the buyer computing device a listing of available event ticket information comprising a plurality of event tickets and associated pricing information, the event ticket information provided by an event server in communication with the loyalty program server to the website; receiving a request on the website to select purchase of a particular live event ticket from the listing in exchange for a pre-defined number of user collected rewards points; processing the request for purchase at the event server to generate a notification message containing details of the request for purchase from the event server to the seller's computing device to request confirmation of availability of the selected ticket; receiving a response at the event server from the seller computing device that the selected ticket is available and providing a confirmation message to the buyer computing device of a completed sale; and settling payment at the event server.

### FIELD

The present application relates generally to a system and method for redeeming loyalty reward points to obtain live event tickets.

### BACKGROUND

The scope of existing reward programs includes subscribed members who purchase goods or services in exchange for a promise by the reward program sponsor to subsequently provide future goods, services or other types of financial value to the subscribed member in order to reward the members for their loyalty to the reward program. Loyalty programs provide to program members (e.g. account holders of the loyalty program) an allotment that can be used for future purchases. It is known that reward programs can also be implemented as employee recognition programs.

It is known in the art to allow the collection and redemption of loyalty rewards or points obtained from interaction with a loyalty program such as airline frequent flyer programs, or financial services loyalty programs, or grocery store loyalty programs, or others envisaged by a skilled person for redemption towards the cost of tangible objects such as consumer products, tickets for airline flights, hotel accommodations, and excursions, among others. This type of loyalty business model essentially is a promise, in gratitude for collecting the loyalty points, to provide the consumer with a defined reward at a later time (once the threshold of loyalty points is met).

### SUMMARY OF THE INVENTION

It would be advantageous to have a system and method which addresses the challenges with redeeming loyalty rewards towards live event tickets.

Provided is a system and method that improves upon existing loyalty systems and their reward product service providers by allowing redemption of accrued loyalty rewards of a subscribed member towards live event tickets. In one embodiment, information on the live event tickets can be presented in either points, cash, gift card values or any combinations thereof in such a way as to allow redemption of loyalty rewards towards a live event ticket purchase. In a preferred embodiment, the redemption system presented herein handles complications relating to dynamic pricing changes and/or other event information updates by allowing dynamic updating and synchronization of pricing information and/or event information. In one example, an event server and a loyalty server cooperate to allow redemption of loyalty rewards towards the purchase of live event tickets.

### BRIEF DESCRIPTION OF THE DRAWINGS

FIG. 1 is a schematic representation of a system for loyalty rewards redemption for live event tickets via an event server;

FIG. 2 is a schematic representation of the event server from FIG. 1;

FIG. 3 illustrates an exemplary flow of interactions among components of the system of FIG. 1 for implementing the rewards redemption system for live event tickets in accordance with one embodiment;

FIG. 4 illustrates a second exemplary flow of interactions among components of the system of FIG. 1 for implementing the rewards redemption system for gift card purchases for a subsequent purchase of the live event tickets in accordance with another embodiment; and

FIG. 5 illustrates an exemplary flow of interactions among components of the system of FIG. 1 for implementing the rewards redemption system in accordance with yet another embodiment.

### DETAILED DESCRIPTION OF THE EMBODIMENTS

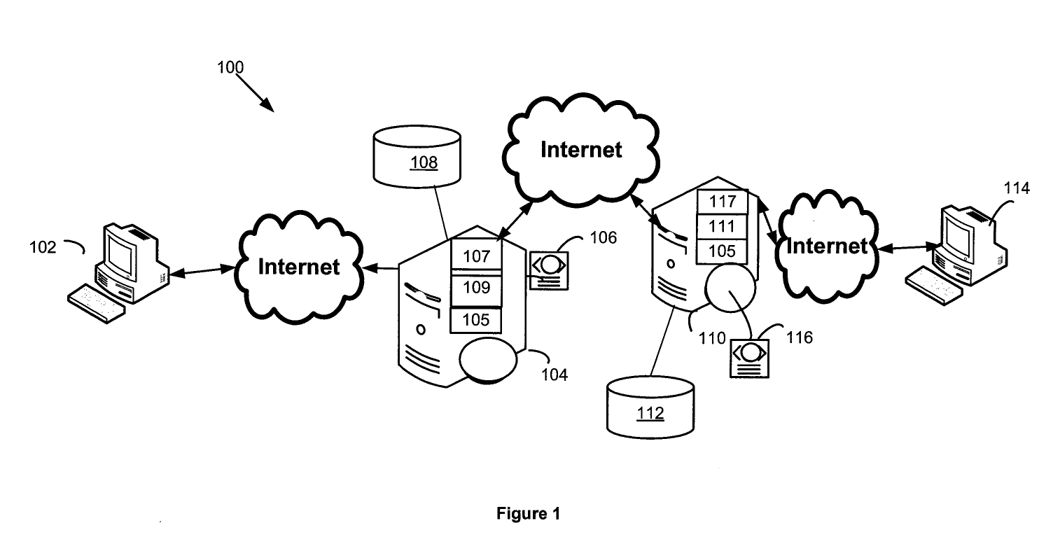

Referring now to FIG. 1, illustrated is a system 100 for redemption of loyalty rewards (e.g. loyalty points, loyalty coupons, or other form of loyalty credit accumulated in a loyalty program account made available to the account holder, etc.) by a client device 102 directed towards the purchase of live event tickets (information of which is accessed via ticket information 105 as further discussed below). The client device 102 communicates via a communications network (e.g. Internet) with one or more servers 104, 110 to initiate and complete a purchase transaction for one or more live event tickets, such that at least a portion of the purchase price of the live event ticket(s) is provided by the redemption of loyalty rewards (e.g. as obtained from the loyalty program account of the client device 102 user or otherwise associated with the client device 102 user—for example a family member of the client device 102 user).

Alternatively, it is also recognized that the client device 102 can transmit to the server 104,110 instructions on an all-cash (or other mode of non-loyalty rewards based payment) transaction for purchase of the live event ticket(s), for those live event tickets selected via accessed ticket information 105. For example, the client device 102 can send instructions to the server 104,110 selecting an option to purchase the live event ticket by disregarding the redemption of user loyalty rewards and instead choosing an alternative non-loyalty reward mode of payment (e.g. cash, coupons, credit card, PayPal account or other payment services or money transfer services, etc.).

The client devices 102 can be operated by users (e.g. loyalty program members having respective loyalty program accounts) to access their loyalty program account hosted by a loyalty program server 104. Vendor devices 114 can be operated by ticket sellers (or vendors) wishing to make their live event ticket(s) available for sale (to the client devices 102) via an event server 110. The loyalty server 104 can be in communication with the event server 110 across a telecommunication network such as the Internet (e.g. an extranet). Alternatively, the loyalty server 104 can be in communication with the event server 110 across a telecommunication network such as a Local Area Network (LAN), otherwise referred to as an intranet. Alternatively, the loyalty server 104 can be in communication with the event server 110 via a computer system bus or other data communications mechanism used to connect major components of a computer system to one another (e.g. internal data bus, address bus, control bus, etc.) in the case where both the loyalty server 104 and the event server 110 are hosted on a common computer device architecture (e.g. hosted on the same computing machine).

The loyalty server 104 can be a web server hosting one or more web sites 107 (referred to as loyalty web sites) and one or more web pages 106 (referred to as loyalty web pages herein). As is recognized herein, the general terminology of website 107 and web pages 106 can be defined to include a network application (e.g. server application such as a mobile application) hosted by the loyalty server 104 for access by the client device 102 via the communications network. The event server 110 is a web server hosting one or more web sites 117 (referred to as event web sites and/or market place) and one or more web pages 116 (referred to as event web pages herein). As is recognized herein, the general terminology of website 117 and web pages 116 can be defined to include a network application (e.g. mobile application) hosted by the event server 110 for access by the client device 102 via the communications network.

Therefore the web pages 106,116 are an example mechanism for making available application specific data (e.g. ticket information 105) as provided by the respective server 104,110 for consumption by the client device 102 via the communications network. For example, a web service is considered as one example of web pages 106,116 which provide the ticket information 105 (or can contain ticket information 105 of the live event tickets as requested by the client device 102). As such, the websites 107,117 and web pages 106,116 (also referred to as network application) are configured to support interoperable machine-to-machine interaction (e.g. between servers 104,110, between client device 102 and server(s) 104,110 and/or between vendor device 114 and server(s) 104,110 over the communications network) for the purposes of access to the ticket information 105 as well as for acting on the accessed ticket information 105 (e.g. selection of live event ticket(s) with corresponding settlement actions to effect a purchase transaction of the selected live event ticket(s)—further described below).

One example of access of ticket information 105 by the client device 102 is where the client device 102 user accesses the loyalty server 104 (e.g. signs into website 107 as a registered loyalty program member) for the purpose of purchasing a product from a rewards catalogue 109 made available to registered loyalty program members. The user would gain access to the ticket information 105 by making respective selections (e.g. clicking on displayed links) from the displayed rewards catalogue 109. Once selected, the user could then request purchase of selected live event ticket(s) with at least a portion of the ticket purchase price being provided by loyalty rewards from the loyalty account of the user.

Accordingly, ticket information 105 of the live event tickets can be accessed by the client device 102 in communications with the loyalty server 104 and/or the event server 110, as further described below for allowing subsequent selection and purchase of the live event tickets. Once purchased, the actual live event ticket(s) would be delivered/sent (e.g. physically delivered, electronically delivered, etc.) to the buyer (e.g. client device 102 user) from the seller (e.g. user of the vendor device 114). It is recognized that communication of the actual live event ticket(s) could be performed directly between the buyer and seller or could be performed indirectly via one or more of the servers 104, 110 (e.g. the seller could email the live event ticket to the event server 110 which could in turn email the live event ticket to the buyer for receipt on the client device 102 once the ticket purchase transaction is completed).

It is recognized that settlement of the purchase transaction can include the steps of: deduction of the requisite loyalty rewards from the loyalty program account of the ticket purchaser, payment (or confirmation thereof) between the operators of the loyalty server 104 (in view of loyalty rewards used to purchase the live event ticket) and the operators of the event server 110, and payment (or confirmation thereof) submitted to the seller (e.g. via the seller device 114) from the operators of the event server 110 for the tickets provided to the buyer (e.g. user of client device 102). In any case, it is recognized that the servers 104,110 could recognize and record receipt/sending (or confirmation thereof) of payment for product or services rendered in association with the purchase transaction of the live event ticket by the buyer.

The system 100 can comprise a plurality of client devices 102 for use by individual buyers to redeem loyalty rewards (e.g. points), obtained and accumulated in relation to a loyalty program, to purchase live event tickets. Ticket information 105 for the live event tickets can be provided to the client device 102 (e.g. via the communications network) formatted in a rewards catalogue 109 (e.g. as part of a catalogue offering live event tickets with other products, or as a separate events catalogue 109 dedicated to live event tickets) and/or in a ticket listing 111 (e.g. a sortable and filterable result list of live event tickets provided in response to a live event ticket query submitted by the client device 102). The information of the rewards catalogue 109 and/or the ticket listing 111 can be represented in the respective websites 107,117 as one or more associated web pages 106,116. The live event tickets are obtained from a number of ticket sellers coupled to the event server 110 via the vendor devices 114, such that the event server 110 can be configured to make available the ticket information 105 to the client device 102 either directly or via the loyalty server 104.

Live event tickets can be defined as a ticket for an event that is held in a venue at a specified time and place. For example, event name, time, place (e.g. including seat selection), and/or cost can be information listed on the live event ticket. A ticket can be defined as a voucher that indicates that one (e.g. the ticket holder) has paid for admission to an event held at a venue (e.g. establishment such as a theatre, movie theater, stadium, concert hall, or other) typically because one has paid the fare (e.g. cost) of the ticket. Also the ticket can be obtained for a percentage of the face value (e.g. less than or greater than face value) and serve as a proof of reservation of the ticket holder for attendance of the event at the specified time and place. The venue can be represented as any of a wide variety of sizes and settings, such as but not limited to private houses and small nightclubs, dedicated concert halls, entertainment centers and parks to large multipurpose buildings, and even sports stadiums. Indoor concerts held in the largest venues are sometimes called “arena concerts” or “amphitheater concerts”. Regardless of the venue, show events (e.g. involving musicians and/or actors) are usually performed on a stage, while sports events (e.g. team-based or individual-based) are usually held on sports associated surfaces such as but not limited to fields, racetracks, rings and other suitable environments. Live events can utilize live event support with professional video, audio, and/or lighting equipment.

As further described below, the ticket information 105 can be accessed by the client device 102 via a website 107 (and associated web pages 106) of a loyalty program server 104 and/or via a website 117 (and associated web pages 116) of an event server 110. For example, the rewards catalogue 109 can be included in the accessed content of web pages 106 and the ticket listing 111 can be included in the web pages 116. However, it is recognized that the web pages 116 could be configured to provide (e.g. display or otherwise communicate—for example in an electronic file or other data stream communicated via the communications network such as in the case where the web pages are embodied as a network application) the rewards catalogue 109 and/or the web pages 106 could be configured to provide (e.g. display or otherwise communicate—for example in an electronic file or other data stream communicated via the communications network such as in the case where the web pages are embodied as a network application) the ticket listing 111. In any case, it is recognized that the provided rewards catalogue 109 or the provided ticket listing 111 contains the ticket information 105 including details (ticket price—dollar cost and/or loyalty rewards cost—ticket quantity, etc.) of the live event tickets desired by the user of the client device 102. It is recognized that the ticket information 105 (e.g. in the catalogue 109 or ticket listing 111) can contain dynamic content that is periodically updated (e.g. on request, automatically every minute, automatically every 20 minutes, etc.), in order to reflect real-time changes in ticket availability, ticket pricing, ticket quantity, as well as other data associated with ticket information 105, as accessed by the user (e.g. loyalty program member) of the client device 102.

In general, loyalty programs provide to program members (e.g. account holders of the loyalty program) an allotment of loyalty rewards that can be used for future purchases. The provision of allotments to the account holder can be triggered when the account holder purchases a product (good or service) that is associated with a particular allotment, for example provided as a percentage of the purchase price of the product. One example is for the purchase of a one hundred dollar product, the loyalty account of the program member is awarded 2 points. Alternatively, upon participating in certain programs (e.g. opening of a new loyalty account or registration in a promotional event), the program member can be awarded a specified allotment of loyalty rewards to their loyalty account, as coordinated by the loyalty program server 104.

The loyalty program server 104 (e.g. a web server hosting a loyalty program web site, designated generally as 107, stored on the web server) can maintain loyalty program accounts associated with loyalty program members and provide loyalty program product information. As such, the loyalty program server 104 can maintain information on how many loyalty rewards (e.g. number of loyalty points or total value of loyalty coupons) are available for redemption in each of the loyalty program accounts of the program members. When requested, the loyalty program server 104 can provide to the event server 110 account information on the amount of loyalty rewards available for redemption associated with selected loyalty program accounts. For example, the event server 110 can receive (e.g. as a notification or as a response to a query) the total number of loyalty points available for redemption by a particular loyalty program member. Alternatively, the event server 110 can receive from the loyalty program server 104 confirmation that a specified number of loyalty rewards is available for redemption. The confirmation or specification of the amount of loyalty rewards available in the selected loyalty program account can be considered as a loyalty reward amount preauthorization, which for example can be received by the event server 110 (e.g. obtained from the loyalty program server 104 upon request and/or notification) as part of the transaction workflow experienced by the client device 102 user in buying one or more live event tickets defined in the ticket information 105. Exemplary account information provided by the loyalty program server 104 can include: total number of loyalty rewards (e.g. loyalty points) as a balance of the loyalty program account that are available for redemption by a particular program member (e.g. balance of account for member X is 100,000 points); and confirmation that the balance of the loyalty program account is greater than a specified loyalty reward quantity (e.g. account of member X can cover redemption of 10,000 points).

In terms of communication with the loyalty server 104, client devices 102 can request and obtain ticket information 105 provided in web pages 106 (or hosted network application) from the web site 107. The web site 107 can be stored (directly or indirectly) on the loyalty server 104 and serve web pages 106 (or hosted network application content) providing access by the client computer 102 to the ticket information 105 (e.g. formatted and contained in the rewards catalogue 109). For ease within the present embodiment, only a single rewards web site 107 and rewards web page 106 (or hosted network application) is shown; however, in another embodiment a plurality of different web sites and web pages (or hosted network applications) can be so coupled. The ticket information 105 can be provided to the loyalty program server 104 by the event server 110, as further described below.

Accordingly, a buyer or purchaser previously enrolled with a loyalty program (also referred to as a subscribed member or loyalty program member) associated with the loyalty server 104 can use the client device 102 for accessing the loyalty program website 107 and associated web pages 106 (or hosted network application) to review loyalty rewards balance available and access desired ticket information 105 (e.g. shown in the rewards catalogue 109), via a loyalty database 108, in order to determine whether or not to redeem loyalty rewards towards the purchase (e.g. using only loyalty rewards from their account) of live event tickets provided in the ticket information 105. As will be understood, a user of a client device 102 can receive authorization from the loyalty program server 104 for viewing and accessing the ticket information 105.

As will be understood, the loyalty server 104 can be associated with, for example, an airline frequent flyer loyalty program, a financial services loyalty program, a vendor specific loyalty program, and other loyalty or rewards programs as understood by a person skilled in the art. In another embodiment, the loyalty server 104 can be associated with employee recognition programs whereas employees can collect loyalty rewards (e.g. points) according to employer defined criteria such as for example, seniority, department specific rewards, or employee involvement in company activities which can similarly be redeemed towards a set of rewards goods such as live event tickets detailed in the ticket information 105. In a manner that is known in the art, a subscriber or member to the loyalty program can collect a number of loyalty rewards (e.g. points) for various goods or services purchased associated with the loyalty program, this reward history (current loyalty account balance and optional account transaction history) for each loyalty program member is stored within the loyalty database 108. Additionally stored in the loyalty database 108 (for access by the loyalty server 104) can be rewards catalogue(s) 109 (detailing services or goods that can be purchased in exchange for redeeming loyalty rewards) that can contain or otherwise be associated with the ticket information 105 that is received from the event server 110.

In the present embodiment, the ticket information 105 can be associated with the rewards catalogue 109 stored in database/storage 108 (FIG. 1), or the ticket information 105 can be associated with the ticket listing 111 using data obtained from the database/storage 112 in FIG. 1. The ticket information 105 provides details on one or more live event tickets that are available for purchase via the event server 110. In one embodiment, the loyalty server 104 obtains information on the live event tickets (e.g. ticket information 105) from the event server 110, for consumption/access by the user of the client device 102 in communication with the loyalty server 104. In another embodiment, the user of the client device 102 first communicates with the loyalty server 104 and then is passed directly to the event server 110 (through the web pages 116 or web site 117) for subsequent selection and purchase of the live event tickets directly from the event server 110. In another embodiment, the user of the client device 102 communicates directly with the event server 110 for subsequent selection and purchase of the live event tickets directly from the event server 110. In either case, preferably the event server 110 is making available the live event tickets for sale to the user of the client device 102 on behalf of a ticket seller (e.g. user of the vendor device 114).

The live event tickets available (e.g. via the rewards catalogue 109) can be filtered by user defined criteria such as location, event type (music/sports/theatre), event details, event cost or according to number of loyalty rewards available to user. In one example, only event tickets requiring a lower number of loyalty rewards (e.g. points) than that collected by the user of the client device 102 are provided by the website 107,117 (e.g. via hosted network application). The rewards catalogue 109 can be interacted with by the user of the client device 102 by accessing loyalty server 104 and/or website 107, for example.

Generally, the loyalty server 104 can be coupled to the database (also can be referred as storage or memory) 108 for retrieving/storing data associated with the client devices 102 or web sites (or hosted network application) or both in accordance with the loyalty server's 104 operations. The database 108 can be a storage (e.g. relational) storing extracted data from web sites (or hosted network application) or navigation history and cookies associated with the client devices 102 or both. The stored data can be accessed by a query (e.g. Structured Query Language (SQL)) to retrieve desired data. Further, the event server 110 can be coupled to the database (also can be referred as storage or memory) 112 for retrieving/storing data associated with the client devices 102 or web sites (or hosted network application) or both in accordance with the event server's 110 operations. The database 112 can be a storage (e.g. relational) storing extracted data from web sites. The stored data can be accessed by a query (e.g. Structured Query Language (SQL)) to retrieve desired data.

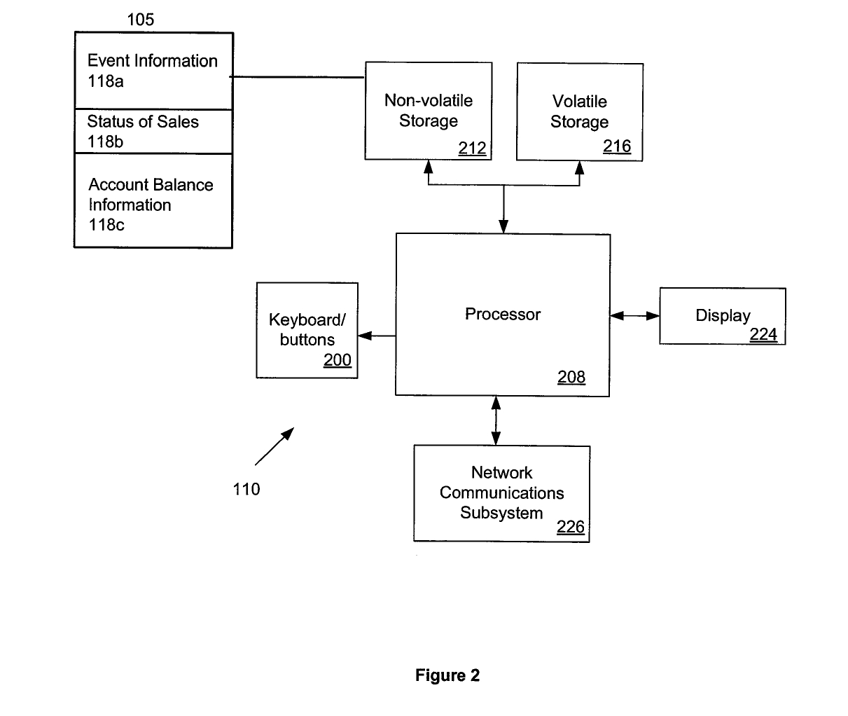

In this manner, the event server 110 can also be coupled to the database 112 for retrieving/storing data associated with various events and tickets provided by web sites 117. In one embodiment, database 112 is a remote or external database while in another embodiment, database 112 refers to one of the non-volatile storage 212 and/or volatile storage 216 (shown in FIG. 2). In one example, the event server 110 is configured to allow buyers and sellers to purchase tickets for local and national music, sporting and theatre events via website 117. In another example, the event server 110 provides a selection of tickets (e.g. stored in database 112) via website 117 and works with users to expand the offering on a scheduled or predefined basis.

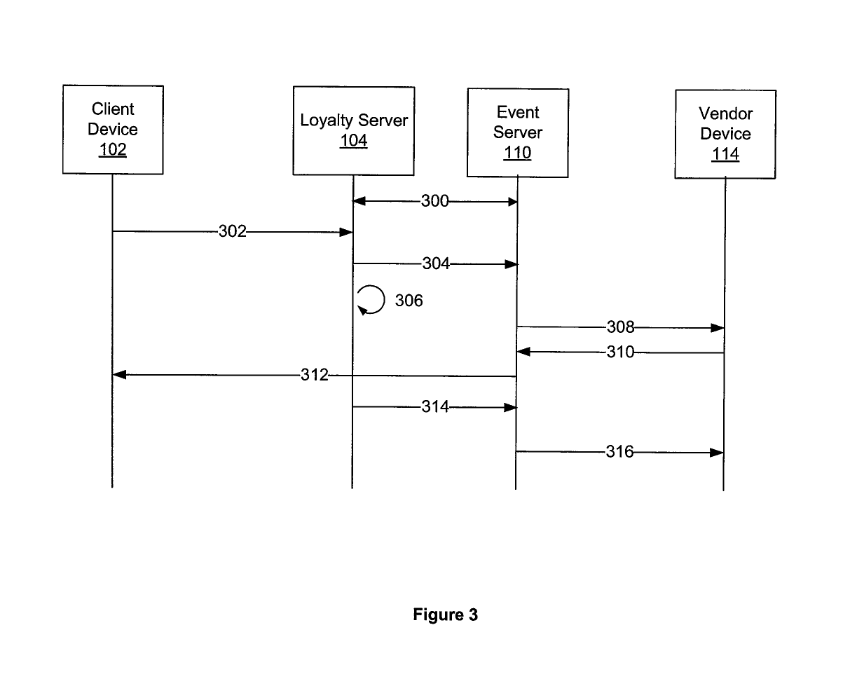

As will be further described in relation to FIGS. 2 and 3, the event server 110 is also further configured for access by a user of client device 102 (previously subscribed to the loyalty program provided by loyalty server 104 and website 107) such that the loyalty server web page 106 (or hosted network application) presents a rewards catalogue 109 including live event ticket information 105 that can be selected for purchase (such as tickets to scheduled events at specific venue locations such as sporting events, theatre, music shows in various regions).

That is, in one embodiment, there is an automated or semi-automated, exchange of information between the loyalty server 104 and event server 110 such as to access live event ticket information 105 on event server 110 and provide same to loyalty server 104 for the rewards catalogue 109. The live event ticket information 105 (and the underlying information related to available events, dates, locations, costs, administration fees) can be provided by push/pull request between the loyalty server 104 and the event server 110. That is, there can be any one of a periodic update or a scheduled update or a user defined update or an event triggered update that causes the push/pull of information between the loyalty server 104 and the event server 110. The push/pull operation can for example determine live ticket information 105 including a current status of ticket offerings or availabilities of event tickets and their updated cost information. Additionally, the push/pull request and/or retrieval of live event ticket information 105 for defining the live event tickets between the loyalty server 104 and the event server 110 can be to verify and/or update and/or add any information (e.g. available events, dates, locations, costs, admin fees) related to the live event tickets according to pre-defined criteria set by the loyalty server 104 and the event server 110 (e.g. only certain live event tickets and/or seat selections and/or venues and/or locations and/or cost ranges that may be available). Further, as described below, the loyalty server 104 also communicates loyalty rewards information associated with the loyalty program account of the user of the client device 102 to the event server 110.

As can be envisaged, allowing live event tickets to be available for purchase on the catalogue of loyalty rewards (e.g. a rewards catalogue 109) presents specific challenges as the event information details (e.g. 118a shown in FIG. 2) including availabilities, costs and venue locations can be constantly changing. That is, the system 100 is advantageous as the loyalty server 104 dynamically (e.g. periodic updates of ticket information 105) communicates with the event server 110 such as to display real-time and up-to-date live event information (e.g. 105) relating to the live events such as the event location, seat and/or row selections/availabilities, and/or cost values and conversion into loyalty rewards on the rewards web page 106 accessible by a user connecting to loyalty server 110 (e.g. via client device 102).

In the present embodiment, in order to purchase event tickets provided by the event server 110 through redemption of loyalty rewards amount(s) confirmed by the loyalty server 110, the event server 110 and live event tickets (e.g. information 105) are accessible via the loyalty server 104 to a user subscribed to the loyalty program and browsing the rewards catalogue 109 associated with live event tickets information 105 on web page 106 (or hosted network application).

According to various embodiments, the operation of system 100 is described generally in relation to FIGS. 2-5. In broad terms, once a ticket request has been inputted for selecting to purchase an event ticket on a website providing the rewards catalogue 109 (e.g. the rewards catalogue 109 can be located on a website associated with either the loyalty server 104, the event server 110 or both), the event server 110 is then configured to confirm availability of tickets with the vendor via the vendor's device 114. During this time, the amount of loyalty rewards dedicated to the purchase of the selected live event tickets is held (e.g. preauthorized) by the loyalty account of the client device 102 user, so as to inhibit use of the loyalty rewards by the member for other purposes before the purchase of the selected live event tickets is either approved or denied, which is dependent on receipt of confirmation (of ticket availability is still valid) from the vendor device 114. The event server 110 sends a loyalty rewards use message to the loyalty server 104, such that the loyalty rewards use message contains details of the number of loyalty rewards associated by the member for use in purchasing the selected live event tickets upon confirmation by the vendor. The loyalty server 104 can use the details of the number of loyalty rewards assigned to the selected live event tickets to place a hold on the loyalty account of the member for the amount of the assigned loyalty rewards. In a preferred embodiment, upon processing the ticket request at the event server 110, the notification message is generated containing details that the seller's live event ticket(s) have been requested/selected by a buyer. The notification message is then provided to the vendor device 114 as a request to confirmation availability of the selected ticket(s) for purchase.

Upon receiving input from the seller via the vendor device 114 (either submitted directly to the event server 110) that the tickets are available, the event server 110 is configured to complete the purchase in communication with the loyalty server 104 and update status of sales information 118b (see FIG. 2). For example, the event server 110 can send (in response to receiving the confirmation of availability of the selected live event tickets) to the loyalty server 104 a message indicating that the live event tickets have been purchased by the member. Therefore the assigned loyalty rewards can be released and therefore deducted from the loyalty account balance of the member (e.g. by the loyalty server 104), thus resulting in a reduction in the loyalty rewards balance of the loyalty account by an amount representative of the assigned loyalty rewards used to purchase the live event tickets. It is recognized that the member can also associate or otherwise indicate that the requisite loyalty rewards associated with the purchase of the selected live event ticket(s) can be obtained by the loyalty server 104 from a specified loyalty program account that is other than that of the member.

The event server 110 is further configured to settle cash value with the loyalty server 104 as per the account balance information 118c related to each event, as well as with the vendor via the vendor device 114. In one embodiment, the seller provides acceptance of the event purchase selection and thus confirmation of the sale is provided from the vendor device 114 directly to the buyer device 102 and/or to the event server 110 and/or to the loyalty server 104 in response to the notification message and the ticket availability request. The confirmation of the sale can be in the form of a notification message, e.g. text, email, SMS or other type of notification message as understood by a person skilled in the art. It is recognized that a hold on assigned loyalty rewards may not be performed in the case where gift cards are first purchased, as further described below.

In general referring to the operation of FIGS. 3-5, access to live event ticket information 105 can be provided either on the loyalty server website 107 via the rewards catalogue 109 or can be provided on the event server website 117 via ticket listing 111. That is, in one embodiment (also see FIG. 3), the user logs in directly to the loyalty server website 107 to view the ticket information 105. In this embodiment, at predefined time intervals or upon request, the event server 110 provides the event listings to populate and/or update the live event ticket information 105 such that the user can review and select event tickets for purchase directly on the loyalty website 107. Once a request for purchase is made with the website 107 then a notification message is sent to the vendor device 114 requesting confirmation of availability of the ticket(s). In this time, the loyalty server 104 communicates the intention for purchase to the event server 110 such that the tickets are held until confirmed by the vendor device 114. Additionally, the loyalty server 104 suspends the loyalty rewards associated with the purchase selection. Upon receiving the confirmation of availability from the vendor device 114, the purchase is completed and the loyalty rewards are deducted from the user's account associated with the loyalty server 104. The sale completion is also communicated from the vendor device 114 to the event server 110, to the loyalty server 104 and to the client device 102. Settlement payment can be confirmed to the event server 110 from the loyalty server 104 to cover the loyalty rewards used and payment is made to the ticket provider, including optionally sending payment confirmation to the vendor device 114 (e.g. via event server 110). Further, it is recognized that the event server 110 could update accounting records to indicate that payment to the seller was sent and payment from the loyalty program was received in connection with the purchase transaction of the live event ticket(s).

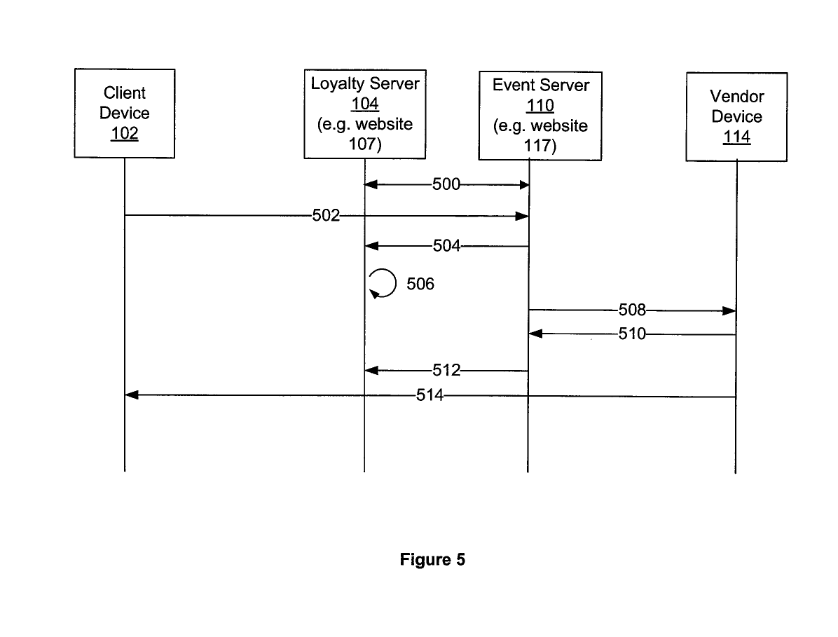

In another embodiment that will be further described in relation to FIG. 5, the user logs in to the loyalty server 104 and is then passed in a continuous session from the loyalty server 104 to the event server 110 (e.g. to the event server website 117) for subsequent access to the ticket listings 111. Alternatively, the user can log in to the event server 110 directly (e.g. to the event server website 117) and access the ticket listings 111. In these embodiments, prior to any purchase being made, the loyalty server 104 can provide to the event server 110 the loyalty rewards history (e.g. balance amount or confirmation of loyalty rewards available) for the user(s). Once a selection of live event tickets for purchase is made, the event server 110 notifies the loyalty server 104 to suspend the assigned loyalty rewards until confirmation (acceptance or denial) is received from the ticket vendor. The loyalty rewards are suspended until the sale is completed and thus the loyalty rewards are deducted from the user's account once the sale is confirmed, or the sale is aborted and thus the loyalty rewards are released. In this case, the event server 110 provides a notification message to the vendor device 114 and requests confirmation of ticket availability, such that upon receiving confirmation of availability, the purchase is completed at the event server 110. Similarly, settlement occurs including that the pre-defined (or assigned) loyalty rewards are deducted from the user's account and payment confirmation is sent/received as discussed above.

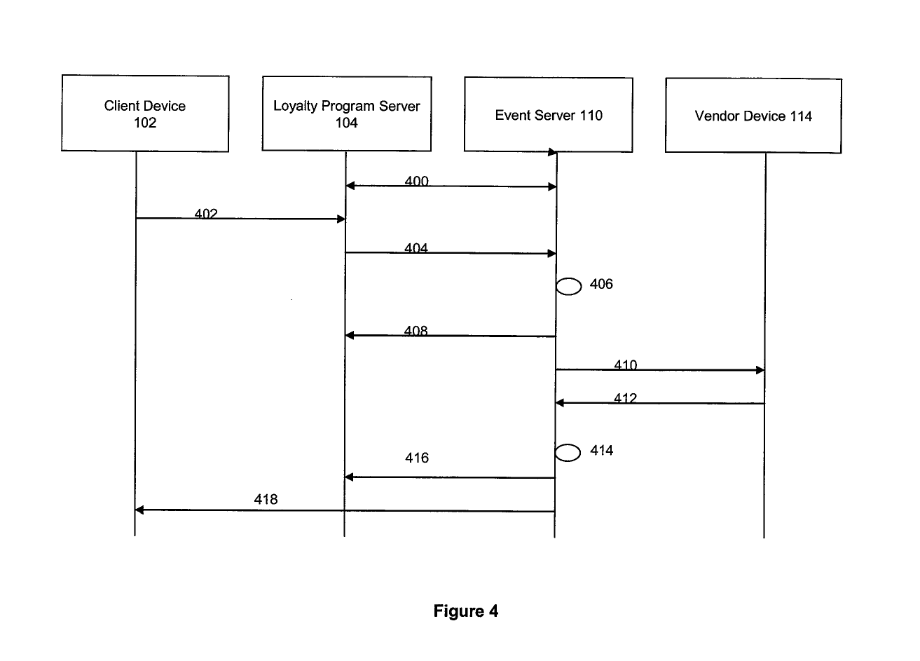

In yet another embodiment that will be further described in relation to FIG. 4, the user of device 102 is able to purchase one or more gift cards with their loyalty rewards and subsequently redeem at least a portion of the gift cards towards the purchase of the live event tickets provided by event website 117.

Referring now to FIG. 3, shown is an exemplary embodiment of the operation of the system 100. At step 300, there is an initial setup and exchange of information between the loyalty server 104 and the event server 110 including a push/pull of event related information for populating live event ticket information 105 in relation to rewards catalogue 109 on a remote loyalty server 104. The rewards catalogue 109 can also be filtered based on pre-defined criteria provided by the loyalty server 104 (e.g. only provide event tickets for venue A and within a defined cost range). That is, the event server 110 provides the live event ticket information 105 to a loyalty server 104 such that the loyalty server 104 can populate its database of live event information that is then available to a subscriber of the loyalty program for purchase/redemption of live event tickets via loyalty rewards listed on rewards catalogue 109.

In reference to FIG. 3, in one embodiment, the event server 110 provides live event ticket information 105 including for example event information details such as ticket pricing information at either predefined intervals or upon request to the loyalty server 104. The request for updating pricing information can be initiated for example, upon a user of device 102 accessing or requesting information about a particular event. In this manner, if a user accesses the website (e.g. 107 in FIG. 1), then real-time live event ticket information 105 including pricing information (e.g. included in event information details 118a) is communicated from the event server 110 to the website (e.g. 107 in FIG. 1) such as to update event information details 118a (e.g. pricing) in a dynamic and real-time manner.

That is, in a similar manner, in reference to FIGS. 3 and 4, the loyalty server 104 provides the event server 110 with cash to loyalty rewards conversion values either periodically or upon request (e.g. from the event server 110).

Accordingly, at step 302, a user of a client device 102 can connect to a loyalty server 104 and access live event ticket information 105 on rewards catalogue 109 (e.g. via website 107 in FIG. 1) such as to subsequently select to purchase tickets to a particular live event by requesting to redeem a defined (e.g. assigned) amount of loyalty rewards based on the ticket value of the selected live event ticket. Each live event ticket in the rewards catalogue 109 can be accessed (e.g. via website 107) in either cash value, loyalty rewards values, or a combination thereof.

At step 304, once a user has selected tickets based on the live event ticket information 105 from rewards catalogue 109, the request is communicated to the event server 110 which is further configured to send a notification (e.g. email, text message, SMS or other digital messages) to a ticket vendor via a vendor's device 114 (at step 308). The ticket vendor's computing device 114 can be associated with a particular event or venue or live event ticket that was selected from available live event ticket information 105 at step 302. At step 306, the loyalty server 104 places the pre-defined amount of loyalty rewards associated with the selected event ticket (e.g. selected at step 302) on hold or suspended until the purchase is confirmed or denied via the event server 110. At step 310, in response to the notification, the vendor confirms availability of the selected event ticket (and either provides a direct response confirmation to the client computing device 102 of the purchase being completed or, in an alternate embodiment, the vendor via device 114 provides a confirmation of availability of tickets and completion of purchase to the event server 110 which then sends the response confirmation to the loyalty server 104 for eventual receipt by the client device 102) at step 312. That is, upon receiving a response that the tickets are available for purchase, the event server 110 proceeds with allowing the sale, and communicates the completion of the sale to the loyalty server 104 and client device 102. Also at step 312, the event server 110 notifies the loyalty server 104 to deduct the loyalty rewards that were previously being held or suspended associated with the purchase.

In turn, at step 314, the loyalty server 104 provides a settlement as discussed above for the value of the predefined amount of loyalty rewards to the event server 110 which marks the ticket as sold (e.g. updates the status of sales 118b and account balance info 118c). For example, at step 316, the event server 110 can provide payment confirmation (e.g. for payment in the form of email money transfer, transfer of funds or other financial means) to the vendor device 114 for the seller's value of the event ticket selected from the rewards catalogue 109.

As described above, once a sale is completed, settlement occurs between the loyalty program server 104, the event server 110 and the vendor device 114. That is, the loyalty rewards used for the purchase are deducted from the purchaser's account associated with the loyalty program server 104 and payments are provided as well as payment confirmations sent and received as noted.

### Gift Card Redemption

Referring now to FIGS. 1 and 4, shown is an alternate embodiment for purchasing live event tickets provided by the event server 110 via loyalty rewards associated with a loyalty server 104. In the previous embodiment referred to in FIG. 3, the loyalty rewards collected by a buyer (associated with client device 102) were used to directly purchase a selected ticket for a live event by redeeming a predefined amount of loyalty rewards accessed by a rewards catalogue 109 at the loyalty server 104. In the present embodiment, the loyalty rewards collected by a member and associated with an account for loyalty program (e.g. stored in server 104) can be redeemed towards a gift card purchase directly with the event server 110. The gift card purchased is subsequently redeemable for purchase of an event ticket selected from ticket listing 111 and live event ticket information 105 (can be with the addition of cash for remaining balance not met through gift card) through the event server 110. In one embodiment, the event server 110 further comprises a plurality of accounts information (e.g. account balance information 118c shown in FIG. 2) stored in database 112, the accounts information 118c stores any residual gift card purchase information associated with a buyer. That is, if the gift cards purchased by the buyer (e.g. via client device 102 and website 117) exceed the value of a particular ticket selected for purchase then the residual amount is stored in the accounts information 118c for subsequent purchases associated with a user.

Referring to FIG. 4, shown is a second exemplary embodiment of the operation of the system 100 of FIG. 1 and event server 110 of FIG. 2. Referring to FIG. 4, at step 400, the event server 110 inquires from the loyalty program server 104 regarding the rewards profile (e.g. rewards history, number of rewards points associated with a user, rewards available for immediate use, suspended rewards) of a subscribed user of the loyalty program server 104 and associated with client device 102. In response, the loyalty program server 104 provides the rewards profile associated with the particular subscribed user. In the present embodiment, the listing 111 of live event tickets is directly accessible via the event server 110 (e.g. stored on database 112 and/or storage 212 coupled to the event server 110). That is, at step 402, a user of a client device 102 logs into the loyalty server website 107 to access the catalogue 109 available (e.g. user previously subscribed to loyalty program). In one example, the user can access a portion of the live event ticket information 105 available and select a desired live event ticket (e.g. via rewards catalogue 109) such as to be redirected to the event server website 117 for accessing the entire live event ticket information 105 directly via the event server website 117 and to allow selection of live event tickets by redeeming loyalty rewards and/or purchasing gift cards as described below.

That is, once the user selects a particular event ticket (or a general live event tickets option that is not specific to any particular live event—e.g. a live events ticket link or button) on website 107 (e.g. the ticket valued at a predefined amount of loyalty rewards and/or cash value), the user is redirected, at step 404, to the event server website 117 and web pages 116 for viewing the ticket listing 111 providing live event ticket information 105. In one embodiment, the ticket prices for each ticket shown in the ticket listing 111 are provided (e.g. displayed) in loyalty rewards values and/or cash values.

In a preferred embodiment shown in FIG. 4, at step 402, a user logs in to the website 107 (e.g. via loyalty program server 104) and is immediately redirected, at step 404, to the event server website 117 for accessing the ticket information 105 which displays a listing of event tickets (e.g. ticket listing 111) available for purchase including event information details 118a (e.g. stored on 112, and 212) directly thereon. At the event server 110, the user can select to purchase one or more gift cards using loyalty rewards (and/or cash) depending on the predefined amount of cash value of the gift card(s). That is, in order to have sufficient funds to purchase the particular ticket, total gift card values exceeding the cash value of the particular ticket can be purchased via loyalty rewards previously collected. In another example, a portion of the cash value of the particular ticket can be met by gift cards and a top up amount (e.g. via cash) provided by the buyer (via client device 102), such that the top up is provided via website 117 and therefore processed via event server 110. In one example, the ticket listing 111 shown on the event server website 117 is provided in cash values and the user is thus aware of the gift card values to be purchased to meet the threshold of the event cash values. In one embodiment, the gift card values provided by the event server 110 can be shown in loyalty rewards values and/or cash value.

In a preferred embodiment, the event server 110 provides a listing of event tickets 111 available for purchase including the live event ticket information 105 (FIG. 2). In the present embodiment, the event server 110 converts the event ticket prices provided by the event information details 118a to loyalty reward values based on an internal cash to rewards valuation (e.g. can be based on a conversion metric previously provided by the loyalty server 104 to the event server 110 at step 400). That is, in a preferred embodiment, the loyalty server 104 provides the event server 110 with the information for converting loyalty rewards collected by a user of device 102 and associated with the loyalty program server 104 to cash value and ticket pricing information associated with the live event tickets on the event server 110.

At step 406, once input is received selecting one or more gift cards for purchase with a certain amount of loyalty rewards of the subscribed user, the event server 110 proceeds at step 408 to notify the loyalty server 104 of the certain amount of loyalty rewards to be deducted from the user's loyalty account (e.g. at the loyalty server 104). The event server 110 then proceeds at step 410 to request confirmation from the seller via device 114 as to whether the particular event ticket previously selected is still available for purchase. The confirmation between the event server 110 and the seller device 114 can be in the form of a text message, SMS, email or other form of notification. Once a response indicating a confirmation is received at step 412 at the event server 110, then the event server 110 denotes the sale as completed and allows the redemption of the gift cards towards the particular event ticket to be confirmed.

At step 414, the event server 110 updates the live event ticket information 105 (e.g. event information details 118a such as availability, status of sales 118b to show the particular sale completed, account balance information 118c to denote the amount of gift card purchased and remaining with a particular user).

At step 416, the event server 110 provides a confirmation to the loyalty server 104 of the transaction being completed and requests from the loyalty server 104, a financial settlement of the loyalty rewards redeemed by the user for the particular purchase (e.g. gift cards purchased). That is, as discussed earlier, once the sale is completed, settlement occurs between the loyalty program server 104, the event server 110 and the vendor device 114. It is recognized that for settlement, the loyalty rewards used for the gift card purchase can be deducted from the purchaser's account (associated with the loyalty program server 104) after confirmation of ticket availability from the vendor device 114. Alternatively, the loyalty rewards used for the gift card purchase can be deducted from the purchaser's account upon notification sent to the loyalty server 104 by the event server 110, which can be done before sending the notification message to the vendor device 114 and/or can be done before receiving confirmation of ticket availability from the vendor device 114. In other words, deduction of loyalty rewards assigned to the purchase of gift cards can be performed with or without confirmation of ticket availability received by the event server 110 from the vendor device 114.

The event server 110 further proceeds at step 418 to notify the client device 102 via email, text message or SMS or other notification methods that the selected event ticket has been purchased. In this manner the sequence of steps defined in FIG. 4, allows for a subscribed user to a loyalty program (e.g. via loyalty server 104) having a first defined amount of loyalty rewards to select event tickets through a ticket listing 111 valued at a certain cash value or loyalty rewards value. The user connects to the event server 110 by the selection and can purchase gift card with the first defined amount of loyalty rewards, the gift card values to cover the certain cash value or loyalty rewards (with or without added cash top-ups) for a live event ticket selected from the ticket listing 111.

In another embodiment illustrated in reference to FIGS. 1 and 5, it can be envisaged that the live event ticket information 105 is provided by the ticket listing 111 and stored on the event server 110 (e.g. database 112) such that the user can access (e.g. directly via the communications network or indirectly via the communications network as facilitated by a pass off by the loyalty server 104) the event server website 117 using the client/buyer device 102. At step 500, the loyalty program server 104 is in communication with the event server 110 either periodically or upon request such as to provide loyalty rewards conversion information as well as loyalty rewards balance/availability for one or more users of client device 102 enrolled in a loyalty program. That is, at step 502, a user accesses the website 117 and can access and select for purchase live event tickets in a ticket listing 111 based on either cash value, loyalty rewards value or a combination thereof.

The event server 110 is thus knowledgeable of the user's current loyalty rewards based on the information provided by the loyalty program server 104 (in either a push/pull relationship such as at step 500). Accordingly, once a request is made for a purchase, the request is communicated (e.g. at step 504) to the loyalty program server 104 which holds or suspends a predefined number of loyalty rewards associated with the live event ticket purchase selection for the user at step 506. At step 508, the event server 110 provides a notification message to the vendor device 114 of an intent to purchase a particular live event ticket and thus requests confirmation of the availability of the particular event ticket from the vendor device 114. Upon receiving confirmation at step 510, the event server 110 completes the transaction and communicates the sale being completed to the loyalty program server 104 (e.g. step 512) and client device 102 (e.g. step 514) in a similar manner as steps 416 and 418 described earlier. That is, the event server 110 can notify the client device 102 via email, text message or SMS or other notification methods that the selected event ticket has been purchased. Further, the event server 110 can notify the loyalty server 104 of the ticket purchase to cause the requisite deduction of loyalty rewards from the loyalty account of the user.

Upon processing the confirmation of the sale, settlement occurs between loyalty server 104, the event server 110 and the vendor device 114 as discussed above. That is, the loyalty server 104 deducts the rewards points associated with the purchase from the user's account. In addition, the loyalty server 104 provides or otherwise causes payment (or confirmation thereof) to be recognized by the event server 110 for the rewards points used towards the purchase of the ticket. The payment provided may be for an amount previously agreed upon between the event server 110 and the loyalty server 104 based on a cash to rewards conversion factor. Additionally, upon completion of the sale, the event server 110 provides or otherwise causes confirmation of financial compensation to be received by the vendor (e.g. via the vendor device 114) for the amount associated with the ticket purchase.

In reference to FIGS. 3, 4, and 5, in one embodiment, the event server 110 receives updated pricing information regarding one or more event tickets from the vendor device 114 (e.g. to update catalogue of rewards 109) and thus the event server 110 communicates this pricing information (e.g. contained within event information 118a) and associated tickets to the website (e.g. 107 or 117) for providing the ticket information 105. As can be understood, this communication of pricing information can occur prior to providing pricing information and associated ticket information 105 via the websites 107 and/or 117. In another embodiment, once a ticket is selected for purchase either via website 107 and/or 117 then the event server 110 is notified to hold or suspend the pricing information (e.g. 118a) associated with the selected ticket until the status of sales 118b is defined as completed and/or until a predefined amount of time has passed and the tickets are then unsuspended. That is, the particular event ticket price is held constant and prevented from increasing during the purchase session with the website 117 or 107 and while redeeming loyalty rewards towards said purchase. In this way, a dynamic pricing update occurs that maintains the pricing information even when tickets are being purchased via loyalty rewards and possibly, gift cards or cash top-ups.

Referring again to FIG. 2, a schematic block diagram shows an exemplary event server 110 in greater detail. The event server 110 includes computer hardware and software components to host websites 117 and deliver event related content and associated web pages 116 (or hosted network applications) to other client computer hardware and/or software components (e.g. loyalty server 104 and/or client device 102 and/or vendor's device 114). As shown in FIG. 1, the event server 110 can also be coupled to external databases 112 such as a relational database storing extracted data from web sites or navigation history or loyalty server's event type or category preferences and cookies associated with the loyalty server 104 or the client device 102 or both. The stored data can be accessed by a Structured Query Language (SQL) to retrieve desired data.

It should be emphasized that the structure in FIG. 2 is purely exemplary, and contemplates a device that may be used for both wireless voice (e.g. telephony) and wireless data (e.g. email, web browsing, text) communications. Event server 110 includes a plurality of input devices which in a present embodiment includes a keyboard and, typically, additional input buttons, collectively 200. Other input devices, such as a touch screen, and camera lens are also contemplated. Input from keyboard/buttons 200 or from external connectivity with components of system 100 in FIG. 1 can be received at a processor 208. Processor 208 can be further operatively coupled with a non-volatile storage unit 212 (e.g. read only memory (“ROM”), Erasable Electronic Programmable Read Only Memory (“EEPROM”), or Flash Memory) and a volatile storage unit 216 (e.g. random access memory (“RAM”), display screen 224. Processor 208 can be operatively coupled for network communications via a subsystem 226. Wireless communications are effective via at least one radio (e.g. 228) such as for Wi-Fi or cellular wireless communications. Event server 110 also can be configured for wired communications such as via a USB or other port and for short range wireless communications such as via a Bluetooth® radio (all not shown).

Programming instructions that implement the functional teachings of event server 110 as described herein are typically maintained, persistently, in non-volatile storage unit 212 and used by processor 208 which makes appropriate utilization of volatile storage 216 during the execution of such programming instructions. Of particular note is that non-volatile storage unit 212 persistently maintains live event ticket information 118 each of which can be executed on processor 208 making use of volatile storage 216 as appropriate. The event server 110 storage means (e.g. non-volatile storage 212 and volatile storage 216) can further be configured for storing live event ticket information 118 including selected event information 118a (e.g. availability of tickets, price of live event ticket . . . ), status of sales 118b (e.g. confirmation of whether an event redemption request was processed and approved by vendor's device 114), account balance info 118c (e.g. any pending settlement information between the loyalty rewards server 104 and the event server 110 and/or between the event server 110 and the seller via the vendor's device 114).

An operating system and various other applications (not shown) are maintained in non-volatile storage unit 212 according to the desired configuration and functioning of client device 102, one specific non-limiting example of which is a contact manager application (also known as an address book, not shown) which stores a list of contacts and contact information of sellers associated with the event information 118 and allows users to view, update, and delete those contacts.

Returning now to FIGS. 1 and 2, the loyalty server 104 and the event server 110 can be based on any commonly available server environments or platforms including a module that houses one or more central processing units, volatile memory (e.g. random access memory), persistent memory (ROM or long-term storage (e.g. hard disk devices)) and network interfaces to allow servers 110 to communicate over the telecommunications network. The event server 110 can host software applications and hardware components comprising instructions and data for generating and serving web pages (or content for hosted network applications) dynamically and for communicating with a rewards based loyalty server 104 for providing updated event information 118a, status of sales 118b, and account balance information 118c as well as other billing and account information related to event and settlement between the loyalty server 104, the seller (via vendor device 114) and in some embodiments, the buyer (via client device 102). A caching or storing feature can also be provided for storing/retrieving live event ticket information data to/from database 112.

Devices 102, 104, 110, 114 and web sites 107, 117 with web pages 106,116 (or hosted network applications) (see FIG. 1) are coupled via a telecommunication network (e.g. Internet, intranet, or a combination thereof) typically comprising a plurality of interconnected networks that can include wired and wireless networks. It should now be understood that the nature of the network is not particularly limited and is, in general, based on any combination of architectures that will support interactions between client devices 102, and seller's device 114 and servers 104 and 110. In a present embodiment the network includes the Internet as well as appropriate gateways and backhauls.

In one example, an event server 110 and a loyalty server 104 cooperate to allow redemption of loyalty rewards towards the purchase of live event tickets. In most common use, a server can be defined as a physical computer (a computer hardware system) dedicated to run one or more services (as a host), to serve the needs of the users of other computers on a network. Depending on the computing service that it offers it could be a database server, file server, web server, or some other kind of server.

In the context of client-server architecture, a server can be a computer program running to serve the requests of other programs, the “clients”. Thus, the server performs some computational task on behalf of “clients.” Either one or both of the servers 104,110 can either run on the same computer device architecture, or they can be embodied on separate computer devices architectures connected through the communications network.

In other examples, the context of Internet Protocol (IP) networking, a server can be a program that operates as a socket listener. Further, it is recognized that servers can provide the ticket information 105 and other related ticket purchase transaction messaging across the communications network, either to private users inside a large organization or to public users via the Internet. As such, a network server can be defined as a computer designed to process requests and deliver data to other (client) computers over a local area network or the Internet. Network servers can typically be configured with additional processing, memory and storage capacity to handle the load of servicing clients. Common types of network servers can include: Web servers; proxy servers; FTP servers; and other servers. Numerous example systems 100 can use this client/server networking model, including Web sites and hosted network application services. An alternative model, peer-to-peer networking enables all computers to act as either a server or client as needed.

1. A computer implemented method for facilitating redemption of loyalty rewards points towards purchase of live event tickets associated with a seller, the loyalty rewards points collected by a user, the rewards points associated with a loyalty program server and accessible by a buyer computing device, the computer implemented method comprising:
providing access via the buyer computing device available event ticket information comprising a plurality of event tickets and associated pricing information, the event ticket information provided by an event server in communication with the loyalty program server;
receiving a ticket request to select purchase of a particular live event ticket from the listing in exchange for a pre-defined number of user collected rewards points;
processing the ticket request for purchase at the event server to generate a notification message containing details of the request for purchase from the event server to the seller's computing device to request confirmation of availability of the selected ticket;
receiving a response at the event server from the seller computing device that the selected ticket is available and providing a confirmation message for the buyer computing device of a completed sale; and
settling of associated payment.

2. The method of claim 1 further comprising, prior to the step of displaying, dynamically providing the pricing information associated with each event ticket from the seller's computing device to the event server.

3. The method of claim 2 further comprising, upon receiving the request, suspending the pricing information associated with the particular live event ticket at a same value for at least one of a predefined time period and until the completed sale.

4. The method of claim 1 further comprising providing a total of rewards points collected by the user for allowing redemption of rewards towards the particular live event ticket.

5. The method of claim 1 further comprising displaying the pricing information for each ticket in the listing in at least one of cash value, and points value.

6. The method of claim 5, further comprising receiving a cash to points conversion metric from the loyalty program server to the event server for displaying the pricing information in points value or receiving a cash to points conversion metric from the event server to the loyalty program server for displaying the pricing information in points value.

7. The method of claim 1 further comprising: in response to receiving the selection, providing instruction from the event server to suspend the pre-defined number of rewards points on the loyalty program server from the buyer until completion or abortion of sale.

8. The method of claim 1 wherein the ticket information is accessed via a website associated with the event server.

9. The method of claim 5 wherein the request for purchase is received from the buyer computing device via the loyalty server.

10. The method of claim 6 further comprising: sending to the loyalty server from the event server a periodic request and receiving availability of rewards points collected by the user to determine whether sufficient points are available for the purchase prior to processing the request for purchase.

11. The method of claim 7 further wherein receiving the request for selecting to purchase the particular live event ticket in exchange for the pre-defined number of rewards points further comprises:
prompting the user to purchase at least one gift card in exchange for at least a portion of the pre-defined number of rewards points;
providing said at least one gift card for subsequent redemption towards the purchase of the live event ticket.

12. The method of claim 1 further comprising: wherein the pre-defined criteria provided by the loyalty server includes selection information selected from the group consisting of: event name, event type, event cost ranges, event location, reward points.

13. The method of claim 8 wherein if a value of the at least one gift card is below the pre-defined number of rewards points required for the purchase, then prompting the user for additional payment for the balance of the ticket for completing the purchase.

14. The method of claim 13 wherein the additional payment requested is in the form of at least one of credit, cash, and gift card payment associated with the user for the balance of the reward points.

15. The method of claim 1 further comprising: accessing and verifying the user's identification information received at the event server with the loyalty server.

16. A computer program product storing instructions and data to configure a processor to perform the method of claim 1.

17. The method of claim 7 further wherein receiving the request for selecting to purchase the particular live event ticket is in exchange for the pre-defined number of rewards points.

18. An event server for facilitating redemption of loyalty rewards points towards purchase of event tickets on a communicatively coupled buyer computing device and a loyalty server associated with a loyalty program database, the event server comprising a processor and a memory coupled thereto, the memory storing instructions and data configuring the processor to perform the method of:
providing a listing of event ticket information from the memory accessible via the buyer computing device according to pre-defined criteria provided by the loyalty server, each ticket available for purchase with rewards points;
receiving a request for selecting to purchase a particular live event ticket from the listing in exchange for a pre-defined number of user collected rewards points;
processing a request received for selecting to purchase a particular live event ticket from the listing in exchange for a pre-defined number of user collected rewards points;
generating a notification message containing details of the request for purchase to a seller computing device communicatively coupled to the event server to request confirmation of availability of the selected ticket;
if a response is received from the seller computing device that the selected ticket is available, then generating a confirmation message to the buyer computing device of a completed sale; and
settling of associated payment.

19. The computer server of claim 18, further comprising, upon receiving the request for purchase, providing instruction from the event server to suspend the pre-defined number of rewards points on the loyalty program server until completion or abortion of the sale.

20. The computer server of claim 18 wherein receiving the request for selecting to purchase the particular live event ticket in exchange for the pre-defined number of rewards points further comprises:
prompting the user to purchase at least one gift card in exchange for at least a portion of the pre-defined number of rewards points;
providing said at least one gift card for subsequent redemption towards the purchase of the live event ticket.
